(19) United States
(12) Patent Application Publication
(10) Pub. No.: US 2025/0220708 A1
(43) Pub. Date: Jul. 3, 2025

(54) Coordinated Peer-to-Peer Transmission Opportunities

(71) Applicant: Cisco Technology, Inc., San Jose, CA (US)

(72) Inventors: Indermeet Gandhi, San Jose, CA (US); Malcolm Smith, Richardson, TX (US)

(21) Appl. No.: 18/586,368

(22) Filed: Feb. 23, 2024

Related U.S. Application Data
(60) Provisional application No. 63/615,724, filed on Dec. 28, 2023.

(51) Int. Cl. H04W 74/0816; H04W 56/00; H04W 74/04; H04W 74/08

(52) U.S. Cl. CPC H04W 74/0816; H04W 56/0015; H04W 74/04; H04W 74/0866

(57) ABSTRACT

Network devices in a wireless deployment may operate on a plurality of different wireless channels. These network devices may also be configured to be in communication with one or more peer-to-peer devices. These peer-to-peer devices may operate on similar wireless channels as the local access points that are serving the end user devices that are connected to the peer-to-peer devices. While various steps can be taken to select peer-to-peer wireless channels that are different from the channel that is servicing the end user devices, these steps may not be configured to account for neighboring AP wireless channels, Thus, as wireless networks become denser, the chances of peer-to-peer wireless channel communications conflicting with nearby access points can increase. Embodiments described herein allow for the configuration of extended or otherwise modified transmission opportunities that are synchronized between multiple access points through a coordinating device, such as a multi-access point coordination (MAPC) device.

### CROSS-REFERENCE TO RELATED APPLICATION

This application claims the benefit of U.S. Provisional Patent Application No. 63/615,724, filed Dec. 28, 2023, which is incorporated by reference herein in its entirety.

The present disclosure relates to wireless networking. More particularly, the present disclosure relates to managing transmission opportunities conducted by at least two APs with peer-to-peer links.

### BACKGROUND

Wi-Fi, or wireless fidelity, is of paramount importance in the modem era as a ubiquitous technology that enables wireless connectivity for a wide range of devices. Its significance lies in providing convenient and flexible internet access, allowing seamless communication, data transfer, and online activities. Wi-Fi has become a cornerstone for connectivity in homes, businesses, public spaces, and educational institutions, enhancing productivity and connectivity for individuals and organizations alike.

Over time, the importance of Wi-Fi has evolved in tandem with technological advancements. The increasing demand for faster speeds, greater bandwidth, and improved security has driven the development of more advanced Wi-Fi standards. However, as technology progresses, the demands of Wi-Fi standards and technologies require increasing evolution and innovations in order to provide enhanced performance, increased capacity, and better efficiency.

Specifically, Peer-to-peer (P2P) communication is becoming an increasingly important capability in Wi-Fi networks to enable direct device-to-device links without traversing the wireless infrastructure.

However, a key limitation is the restricted transmission opportunity (TxOP) allocated for P2P within the contention-based channel access mechanism of Wi-Fi networks. The duration of P2P TxOPs is determined by the wireless access point (AP) and is interleaved with downlink and uplink transmissions between the AP and its associated stations (devices). This fragmented structure of P2P TxOPs limits the size of data bursts and throughput that can be achieved on the direct P2P link.

### SUMMARY OF THE DISCLOSURE

Systems and methods for managing transmission opportunities conducted by at least two APs with peer-to-peer links in accordance with embodiments of the disclosure are described herein.

In some embodiments, a peer-to-peer management logic is configured to configure the at least one wireless transceiver on a first transmission channel, receive a request for a first transmission opportunity (TxOP), allocate an initial TxOP slot schedule for a first client device, share the initial TxOP slot schedule with a coordinating device, receive an expanded TxOP slot schedule, and transmit the expanded TxOP slot schedule to one or more end user devices.

In some embodiments, the first transmission opportunity is a peer-to-peer transmission opportunity (TxOP).

In some embodiments, the peer-to-peer TxOP is received from the first client device.

In some embodiments, the first client device is configured with a peer-to-peer connection with a first peer-to-peer device.

In some embodiments, the expanded TxOP slot schedule is associated with a neighboring access point.

In some embodiments, the neighboring access point is configured to execute the expanded TxOP slot schedule with a second client device.

In some embodiments, the second client device is configured with a peer-to-peer connection to a second peer-to-peer device.

In some embodiments the second peer-to-peer device is configured with a wireless transceiver.

In some embodiments, the wireless transceiver of the second peer-to-peer device is also configured on the first transmission channel.

In some embodiments, the expanded TxOP slot schedule is configured to avoid interference between transmissions occurring on the first transmission channel.

In some embodiments, the coordinating device is a multi-access point coordinator (MAPC) device.

In some embodiments, the peer-to-peer management logic is further configured to perform a data transfer.

In some embodiments, a peer-to-peer management logic is configured to establish an inter-access point communication with at least a first access point and a second access point, receive an indication of a peer-to-peer connection, select a plurality of neighboring access points, gather channel data associated with the peer-to-peer connection and the plurality of neighboring access points, and compare the channel data associated with the peer-to-peer connection to the channel data associated with the neighboring access points, and initialize, in response to the channel data matching the peer-to-peer connection, an inter-access point synchronization routine.

In some embodiments, the peer-to-peer connection is between a peer-to-peer device and an end user device in wireless communication with the first access point or the second access point.

In some embodiments, the plurality of neighboring access points are selected based on their proximity to the first access point associated with the peer-to-peer connection.

In some embodiments, the channel data is configured to indicate a wireless channel being utilized by a wireless transceiver.

In some embodiments, the inter-access point synchronization routine is a multi-access point coordination routine.

In some embodiments, the peer-to-peer device is further configured to determine a plurality of transmission opportunity (TxOP) schedules.

In some embodiments, managing peer-to-peer connections includes configuring a transceiver to a first transmission channel, receiving a request for a first transmission opportunity (TxOP), allocating an initial TxOP slot schedule for a first client device, sharing the initial TxOP slot schedule with a coordinating device, receiving an expanded TxOP slot schedule, and transmitting the expanded TxOP slot schedule to one or more end user devices.

In some embodiments, managing peer-to-peer connections further includes transmitting data according to the expanded TxOP slot schedule.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system, in accordance with various embodiments of the disclosure;

FIG. 2 is a schematic block diagram of a call flow in a power management system, in accordance with various embodiments of the disclosure;

FIG. 3 is a conceptual network diagram of various environments that a networking logic may operate on a plurality of network devices, in accordance with various embodiments of the disclosure;

FIG. 4 is a conceptual diagram of a peer-to-peer environment with one or more channel conflicts, in accordance with various embodiments of the disclosure;

FIG. 5 is a flowchart depicting a process for directing peer-to-peer communications in accordance with various embodiments of the disclosure;

FIG. 6 is a flowchart depicting a process for managing neighboring access points in accordance with various embodiments of the disclosure;

FIG. 7 is a flowchart depicting a process for initializing an inter-access point synchronization routine in accordance with various embodiments of the disclosure;

FIG. 8 is a flowchart depicting a process for transmission opportunity scheduling between access points in accordance with various embodiments of the disclosure; and

FIG. 9 is a conceptual block diagram of a device suitable for configuration with a peer-to-peer management logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

With maximum AP TxOP durations in the range of a few milliseconds (e.g. 4 ms), many emerging P2P use cases involving real-time high-bandwidth applications cannot be supported. P2P TxOP duration is not bound by AP TxOP duration and may need larger TxOP to transmit large bursts for uses like VR content streaming, screen casting/mirroring etc. In many embodiments, to achieve the goal of deterministically concatenating P2P TxOPs from two or more APs, various inter-AP related mechanisms are proposed.

Nowadays, the consumption of high-bandwidth and real time applications constitutes a massive challenge for operators and network companies to deliver these contents to end users. Beyond traditional video streaming consumption, cloud gaming, virtual and augmented reality (VR/AR) are rapidly becoming more and more popular, hence further contributing to and increasing the demand of interactive and delay-sensitive contents. To address this, Wi-Fi networks are constantly evolving to handle the high requirements of these applications in terms of throughput and/or latency, but also the increasing number of users and the traffic volume on the Internet. Access Point (AP) densification (i.e., covering the same area with a high number of APs) has been the natural response to cope with such situations. This approach allows stations to benefit from high Signal-to-Noise (SNR) levels, as they are close to their serving APs, resulting in the use of high-transmission rates. However, when the number of co-located APs is high, the limited number of frequency channels may result in detrimental high contention and interference levels, as well as affecting the ability of the Wi-Fi networks to provide a reliable service. A solution to mitigate the high contention levels in dense Wi-Fi deployments is to coordinate transmissions from the set of overlapping APs.

To support such an objective, the Multi-Access Point Coordination (MAPC) framework was initially included as part upcoming Wi-Fi standards. MAPC allows APs to share time, frequency and/or spatial resources in a controlled manner, alleviating Overlapping Basic Service Set (OBSS) contention, and enabling the implementation of WLAN-level scheduling mechanisms. MAPC aims to improve the overall network performance by allowing Access Points (APs) to share time, frequency and/or spatial resources in a coordinated way, thus alleviating inter-AP contention and enabling new multi-AP channel access strategies.

In wireless networking, a TXOP, or Transmission Opportunity, refers to a time interval during which a wireless station or device has the exclusive right to transmit data over the wireless medium. It is a concept associated with the IEEE 802.11 standard, commonly known as Wi-Fi. The TXOP mechanism is designed to improve network efficiency and reduce contention by allocating specific time slots for data transmission. It helps in managing the shared communication medium by preventing multiple stations from attempting to transmit simultaneously, thereby reducing collisions, and enhancing overall network performance. The TXOP is part of the medium access control (MAC) layer in the IEEE 802.11 standard and plays a crucial role in optimizing the utilization of the available wireless bandwidth.

Frequency Division Multiple Access (FDMA) is a type of channelization protocol. In this setup, bandwidth is divided into various frequency bands. Each network device is allocated with a band to send data and that band is reserved for that particular network device for a specified time. The frequency bands of different network devices are separated by a small band of unused frequency and that unused frequency bands are often referred to as guard bands that can prevent the interference of other network devices.

Time Division Multiple Access (TDMA) is a channelization protocol in which the bandwidth of a channel is divided into various network devices on a time basis. There is a time slot given to each network device, which can transmit data during that time slot only. Each network device should be aware of its time slot beginning and the location of the time slot. TDMA often requires synchronization between the different network devices.

In Code Division Multiple Access (CDMA), all of the network devices can transmit data simultaneously. It allows each network device to transmit data over the entire frequency all the time. Multiple simultaneous transmissions are separated by a unique code sequence, wherein each user is assigned with a unique code sequence.

In a number of embodiments, a new inter-AP control protocol can be defined to exchange scheduling information outside of TxOPs or more strictly of other APs scheduled TXOPs that may not be currently coordinated (e.g., by the MAPC CG). This can allow each AP to maintain a coordinated view of TxOP allocations across APs and schedule subsequent TxOPs accordingly. In practice, the MAPC CQ Leader may be one such entity to schedule the multi-AP TXOPs. In certain embodiments, the protocol leverages the use of short-duration, high-priority coordination messages transmitted in reserved inter-AP coordination slots or network-comms either direct to AP or via MAPC CG Leader.

In some embodiments, these coordination slots can be time division multiplexed with conventional Wi-Fi transmission slots and occur at defined periodic intervals, e.g. every 10 milliseconds. Those skilled in the art will recognize that protocol inter-frame-separators (IFS, DIFS, AIFS) and re-starting of LBT/CSMA is not strictly required between these TXOPs taken by the P2P device since they are not part of the BSS and simply need to respect broader spectrum usage policy. In further embodiments, coordination messages can use various frame formats, such as, but not limited to timestamp frames to synchronize scheduling decisions across APs; TxOP schedule frames which can indicate TxOP allocations for both downlink and P2P links; and availability frames which can indicate AP's that are in a free or busy state outside of the TxOPs.

In further embodiments, precise timing synchronization between APs can be required to coordinate their TxOP schedules and transmissions. Inter-AP Synchronization methods may allow APs to dynamically adjust TxOP boundaries to contiguously join P2P TxOPs. In some embodiments, the desired synchronization accuracy can be in the order of a few microseconds to ensure contiguous transmission between TxOPs.

In still more embodiments, the synchronized inter-AP coordination can allow for construction of extended P2P TxOPs spanning both cells. Embodiments that can achieve this may include a first device requesting a P2P TxOP from a first AP based on its traffic requirements. The first AP may allocate an initial TxOP slot for the first device and share this info with a second AP using a coordination protocol (e.g., via MAPC). In some embodiments, the second AP can expand the TxOP by allocating contiguous extension on its side for a second device. The first and second AP can subsequently indicate the extended TxOP schedule to the first and second device respectively. In this way, the stations may be configured to perform a seamless P2P transmission spanning both APs.

The TxOP extension parameters can be optimized dynamically based on the stations' traffic characteristics and application needs. In various embodiments, the use of dedicated inter-AP coordination slots for out-of-band scheduling synchronization between APs is achieved. In still further embodiments, a mechanism for tight inter-AP synchronization to align P2P TxOP boundaries through coordination protocol exchange can be configured. Finally, in a number of embodiments, concatenating P2P TxOPs allocated across multiple APs based on synchronized coordination (e.g. based on application requirements) may be realized.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

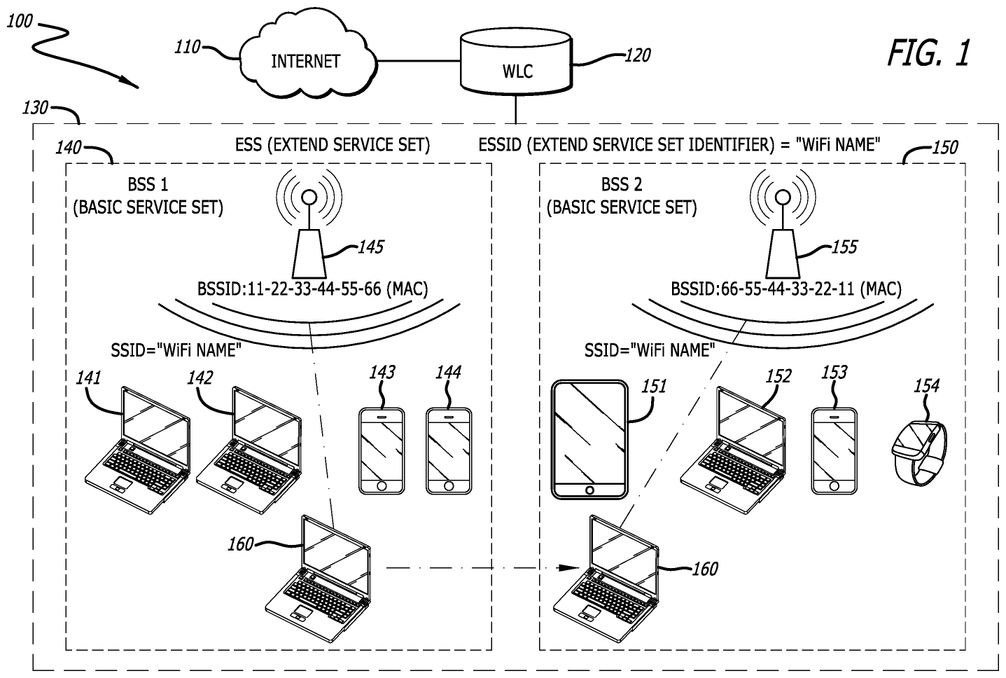

Referring to FIG. 1, a schematic block diagram of a wireless local networking system 100, in accordance with various embodiments of the disclosure is shown. Wireless local networking standards play a crucial role in enabling seamless communication and connectivity between various devices within localized areas. One of the most prevalent standards is Wi-Fi, is based on the IEEE 802.11 family of protocols. Wi-Fi provides high-speed wireless access to the internet and local network resources, with iterations such as 802.11a, 802.11b, 802.11g, 802.11n, 802.11ac, and 802.11ax, each offering improvements in speed, range, and efficiency. Each adoption of Wi-Fi standards is often designed to bring enhanced performance, increased capacity, and better efficiency in crowded network environments, Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks, Within a service set, the nodes—comprising devices like laptops, smartphones, or other Wi-Fi-enabled devices—operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS), A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a basic service set identifier (BSSID), a 48-bit label adhering to MAC-48 conventions. Despite the possibility of a device having multiple BSSIDs, each BSSID is typically associated with, at most, one basic service set at any given time.

It's crucial to note that a basic service set should not be confused with the coverage area of an access point, which is referred to as the basic service area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the basic service area defines the spatial extent of an access point's wireless reach. Understanding these distinctions is fundamental for effectively configuring and managing wireless networks, ensuring optimal performance and coordination among connected devices.

The service set identifier (SSID) defines a service set or extends service set. Normally it is broadcast in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device has associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

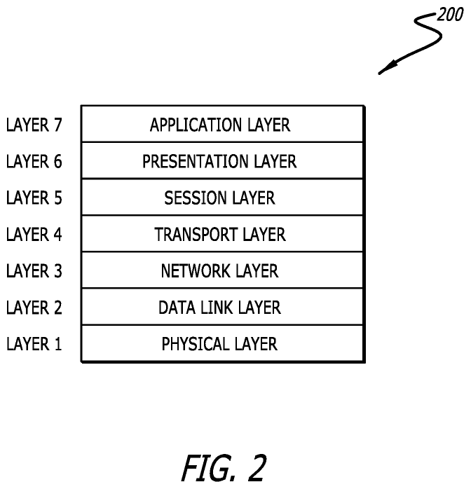

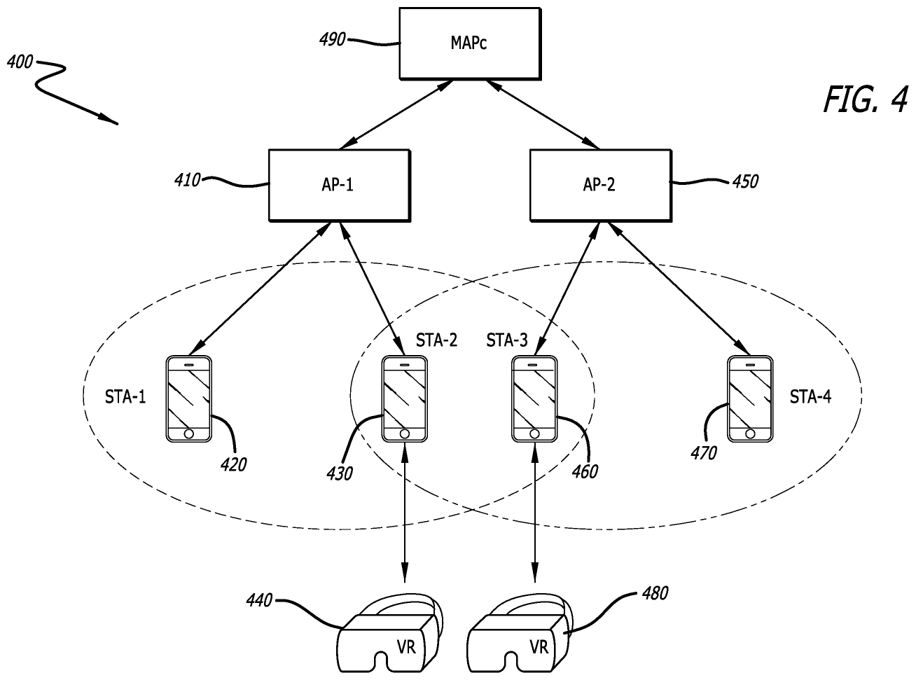

The network can include a variety of user end devices that connect to the network. These devices can sometimes be referred to as stations (i.e., “STAs”). Each device is typically configured with a medium access control (“MAC”) address in accordance with the IEEE 802.11 standard. As described in more detail in FIG. 2, a physical layer can also be configured to communicate over the wireless medium. As described in more detail of FIG. 4, various devices on a network can include components such as a processor, transceiver, user interface, etc. These components can be configured to process frames of data transmitted and/or received over the wireless network. Access points (“APs”) are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS 130). The ESS 130 comprises two separate basic service sets (BSS 1 140 and BBS 2 150). The ESS 130, BSS 1 140 and BSS 2 150 all broadcast and are configured with the same SSID “WiFi Name”, which can be a BSSID for each of the BSS 1 140 and BSS 2 150 as well as a ESSID for the ESS 130.

Within the first BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices can communicate with the first access point 145. Likewise, in the second BSS 2 150, the network comprises a first tablet 151 (shown as “tablet1”), a fourth notebook 152 (shown as “notebook4”), a third phone 153 (shown as “phone3”), and a first watch 154 (shown as “watchl”). The third notebook 160 is communicatively collected to both the first BSS 1 140 and second BSS 2 150. In this setup, third notebook 160 can be seen to “roam” from the physical area serviced by the first BSS 1 140 and into the physical area serviced by the second BSS 2 150.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-5 as required to realize a particularly desired embodiment.

Referring to FIG. 2, a conceptual depiction of a communication layer architecture 200 in accordance with various embodiments of the disclosure is shown. In many embodiments, the communication layer architecture 200 can be utilized to carry out various communications described or required herein. In still more embodiments, the communication layer architecture 200 can be configured as the open systems interconnection model, more commonly known as the OSI model. Likewise, the communication layer architecture 200 may have seven layers which may be implemented in accordance the OSI model.

In the embodiment depicted in FIG. 2, the communication layer architecture 200 includes a first physical layer, which can serve as the foundational layer among the seven layers. It is responsible for the transmission and reception of raw, unstructured data bits over a physical medium, such as cables or wireless connections. At this layer, the focus is on the electrical, mechanical, and procedural characteristics of the hardware, including cables, connectors, and signaling. The primary goal is to establish a reliable and efficient means of physically transmitting data between devices. The physical layer doesn't concern itself with the meaning or interpretation of the data; instead, it concentrates on the fundamental aspects of transmitting binary information, addressing issues like voltage levels, data rates, and modulation techniques. Devices operating at the physical layer include network cables, connectors, repeaters, and hubs. The physical layer's successful operation is fundamental to the functioning of the entire OSI model, as it forms the bedrock upon which higher layers build their more complex communication protocols and structures.

In some embodiments, the communication layer architecture 200 can include a second data link layer which may be configured to be primarily concerned with the reliable and efficient transmission of data between directly connected devices over a particular physical medium. Its responsibilities include framing data into frames, addressing, error detection, and, in some cases, error correction. The data link layer is divided into two sublayers: Logical Link Control (LLC) and Media Access Control (MAC). The LLC sublayer manages flow control and error checking, while the MAC sublayer is responsible for addressing devices on the network and controlling access to the physical medium. Ethernet is a common example of a data link layer protocol. This layer ensures that data is transmitted without errors and manages the flow of frames between devices on the same local network. Bridges and switches operate at the data link layer, making forwarding decisions based on MAC addresses. Overall, the data link layer plays a crucial role in creating a reliable point-to-point or point-to-multipoint link for data transmission between neighboring network devices.

In various embodiments, the communication layer architecture 200 can include a third network layer which can be configured as a pivotal component responsible for the establishment of end-to-end communication across interconnected networks. Its primary functions include logical addressing, routing, and the fragmentation and reassembly of data packets. The network layer ensures that data is efficiently directed from the source to the destination, even when the devices are not directly connected. IP (Internet Protocol) is a prominent example of a network layer protocol. Devices known as routers operate at this layer, making decisions on the optimal path for data to traverse through a network based on logical addressing. The network layer abstracts the underlying physical and data link layers, allowing for a more scalable and flexible communication infrastructure. In essence, it provides the necessary mechanisms for devices in different network segments to communicate, contributing to the end-to-end connectivity that is fundamental to the functioning of the internet and other large-scale networks.

In additional embodiments, the fourth transport layer, can be a critical element responsible for the end-to-end communication and reliable delivery of data between devices. Its primary objectives include error detection and correction, flow control, and segmentation and reassembly of data. Two key transport layer protocols are Transmission Control Protocol (TCP) and User Datagram Protocol (UDP). TCP ensures reliable and connection-oriented communication by establishing and maintaining a connection between sender and receiver, and it guarantees the orderly and error-free delivery of data through mechanisms like acknowledgment and retransmission. UDP, on the other hand, offers a connectionless and more lightweight approach suitable for applications where speed and real-time communication take precedence over reliability. The transport layer shields the upper-layer protocols from the complexities of the network and data link layers, providing a standardized interface for applications to send and receive data, making it a crucial facilitator for efficient, end-to-end communication in networked environments.

In further embodiments, a fifth session layer, can be configured to play a pivotal role in managing and controlling communication sessions between applications. It provides mechanisms for establishing, maintaining, and terminating dialogues or connections between devices. The session layer helps synchronize data exchange, ensuring that information is sent and received in an orderly fashion. Additionally, it supports functions such as checkpointing, which allows for the recovery of data in the event of a connection failure, and dialog control, which manages the flow of information between applications. While the session layer is not as explicitly implemented as lower layers, its services are crucial for maintaining the integrity and coherence of data during interactions between applications. By managing the flow of data and establishing the context for communication sessions, the session layer contributes to the overall reliability and efficiency of data exchange in networked environments.

In still more embodiments, the communication layer architecture 200 can include a sixth presentation layer, which may focus on the representation and translation of data between the application layer and the lower layers of the network stack. It can deal with issues related to data format conversion, ensuring that information is presented in a standardized and understandable manner for both the sender and the receiver. The presentation layer is often responsible for tasks such as data encryption and compression, which enhance the security and efficiency of data transmission. By handling the transformation of data formats and character sets, the presentation layer facilitates seamless communication between applications running on different systems. This layer may then abstract the complexities of data representation, enabling applications to exchange information without worrying about differences in data formats. In essence, the presentation layer plays a crucial role in ensuring interoperability and data integrity between diverse systems and applications within a networked environment.

Finally, the communication layer architecture 200 can also comprise a seventh application layer which may serve as the interface between the network and the software applications that end-users interact with. It can provide a platform-independent environment for communication between diverse applications and ensures that data exchange is meaningful and understandable. The application layer can encompass a variety of protocols and services that support functions such as file transfers, email, remote login, and web browsing. It acts as a mediator, allowing different software applications to communicate seamlessly across a network. Some well-known application layer protocols include HTTP (Hypertext Transfer Protocol), FTP (File Transfer Protocol), and SMTP (Simple Mail Transfer Protocol). In essence, the application layer enables the development of network-aware applications by defining standard communication protocols and offering a set of services that facilitate robust and efficient end-to-end communication across networks.

Although a specific embodiment for a communication layer architecture 200 is described above with respect to FIG. 2, any of a variety of systems and/or processes may be utilized in accordance with embodiments of the disclosure. For example, various aspects described herein may reside or be carried out on one layer, or a plurality of layers. The elements depicted in FIG. 2 may also be interchangeable with other elements of FIG. 1 and FIGS. 3-5 as required to realize a particularly desired embodiment.

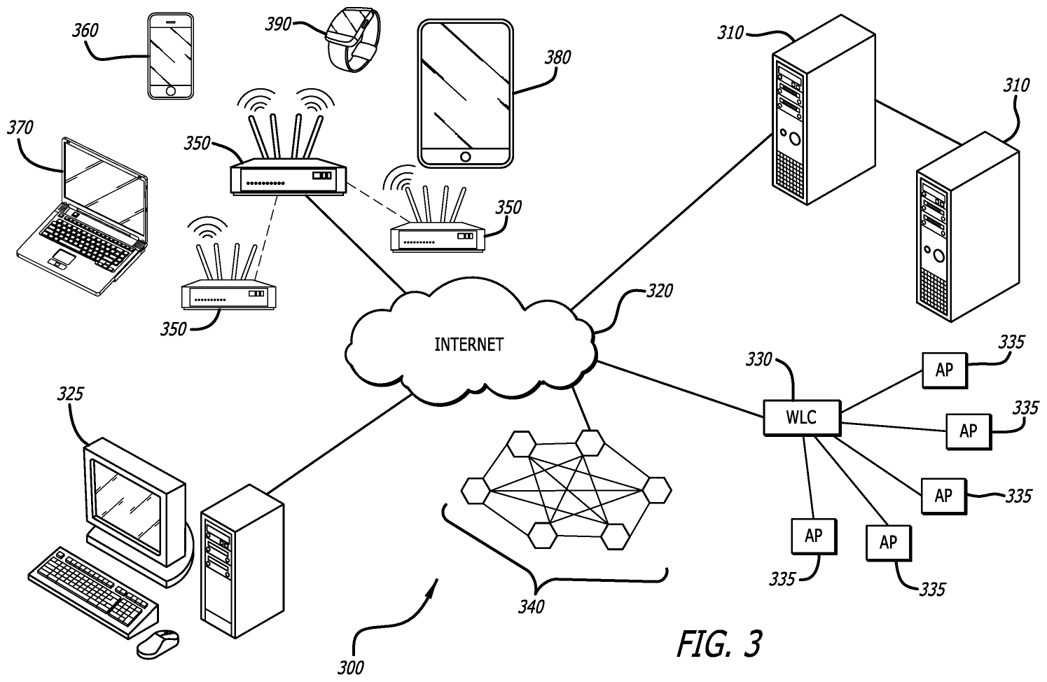

Referring to FIG. 3, a conceptual network diagram 300 of various environments that a networking logic may operate on a plurality of network devices, in accordance with various embodiments of the disclosure is shown. Those skilled in the art will recognize that the networking logic can include various hardware and/or software deployments and can be configured in a variety of ways. In many embodiments, the networking logic can be configured as a standalone device, exist as a logic in another network device, be distributed among various network devices operating in tandem, or remotely operated as part of a cloud-based network management tool. In further embodiments, one or more servers 310 can be configured with the networking logic or can otherwise operate as the networking logic. In many embodiments, the networking logic may operate on one or more servers 310 connected to a communication network 320 (shown as the “Internet”). The communication network 320 can include wired networks or wireless networks. The networking logic can be provided as a cloud-based service that can service remote networks, such as, but not limited to a deployed network 340.

However, in additional embodiments, the networking logic may be operated as a distributed logic across multiple network devices. In the embodiment depicted in FIG. 3, a plurality of network access points (APs) 350 can operate as the networking logic in a distributed manner or may have one specific device operate as the networking logic for all of the neighboring or sibling APs 350. The APs 350 may facilitate Wi-Fi connections for various electronic devices, such as but not limited to, mobile computing devices including laptop computers 370, cellular phones 360, portable tablet computers 380 and wearable computing devices 390.

In further embodiments, the networking logic may be integrated within another network device. In the embodiment depicted in FIG. 3, a wireless LAN controller (WLC) 330 may have an integrated networking logic that the WLC 330 can use to monitor or control power consumption of the APs 335 that the WLC 330 is connected to, either wired or wirelessly. In still more embodiments, a personal computer 325 may be utilized to access and/or manage various aspects of the networking logic, either remotely or within the network itself. In the embodiment depicted in FIG. 3, the personal computer 325 communicates over the communication network 320 and can access the networking logic of the servers 310, or the network APs 350, or the WLC 330.

Although a specific embodiment for various environments that the networking logic may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the networking logic may be provided as a device or software separate from the WLC 330 or the networking logic may be integrated into the WLC 330. The elements depicted in FIG. 3 may also be interchangeable with other elements of FIGS. 1-2 and FIGS. 4-5 as required to realize a particularly desired embodiment.

Referring to FIG. 4, a conceptual diagram of a peer-to-peer environment with one or more channel conflicts, in accordance with various embodiments of the disclosure is shown. In many embodiments, the APs can be assumed to be within communication range of each other. However, the devices may be outside the range of each other's AP and hence rely on their associated AP for scheduling dedicated peer-to-peer (P2P) transmission opportunities (TxOPs). With certain embodiments, the length of individual P2P TxOP allocated by each AP can be limited. Some embodiments described herein, attempt to solve the specific problem of how to effectively concatenate or join the TxOPs scheduled independently by two APs to create one extended transmission opportunity for the P2P link spanning both APs' coverage area. Simply extending the P2P TxOP independently on each AP can result in collisions and intermittent connectivity as the devices go out of range of their associated AP during the TxOP.

The embodiment depicted in FIG. 4 shows a specific scenario where a coordinating or otherwise concatenated TxOP schedule can be utilized to improve network efficiency. In some embodiments, a first access point 410 (shown as AP-1), and a second access point 450 (shown as AP-2) are configured to operate in a deployed area such that they are neighboring APs. In the embodiment depictured in FIG. 4, both the first access point 410 and the second access point 450 are servicing two client devices. Specifically, the first access point 410 is in communication with a first client device 420 (shown as STA-1), and a second client device 430 (shown as STA-2). The second access point 450 is in communication with a third client device 460 (shown as STA-3), and the forth access point 470 (shown as STA-4).

In the same embodiment, the second client device 430 has a peer-to-peer connection with a first virtual reality system 440 and likewise, the third client device 460 has a peer-to-peer connection with a second virtual reality system 480. Because of the neighboring state of the first access point 410 and the second access point 450, a coordinating device is utilized, specifically a multi-access point coordinating device 490 (shown as MAPc). The coordinating device 490 can be configured to coordinate actions between the first access point 410 and the second access point 450.

In some embodiments, the communication between the first access point 410 and the second end user device 430 can be conducted on a first channel. Likewise, the wireless communication between the third end user device 460 and the second virtual reality system 480 may also operate on the first channel. This can cause communication issues as channel conflicts can lead to interruptions and other negative outcomes. As such, numerous embodiments described herein can address such scenarios by coordinating, extending, concatenating, and otherwise processing transmission opportunities between various access points, end user devices, and peer-to-peer devices.

Although a specific embodiment for a peer-to-peer environment with one or more channel conflicts suitable for carrying out the various steps, processes, methods, and operations described herein is discussed with respect to FIG. 4, any of a variety of systems and/or processes may be utilized in accordance with embodiments of the disclosure. For example, the number of devices that may be affected by similar channel issues can vary depending on the specific deployment encountered. The elements depicted in FIG. 4 may also be interchangeable with other elements of FIGS. 1-3 and 5-9 as required to realize a particularly desired embodiment.

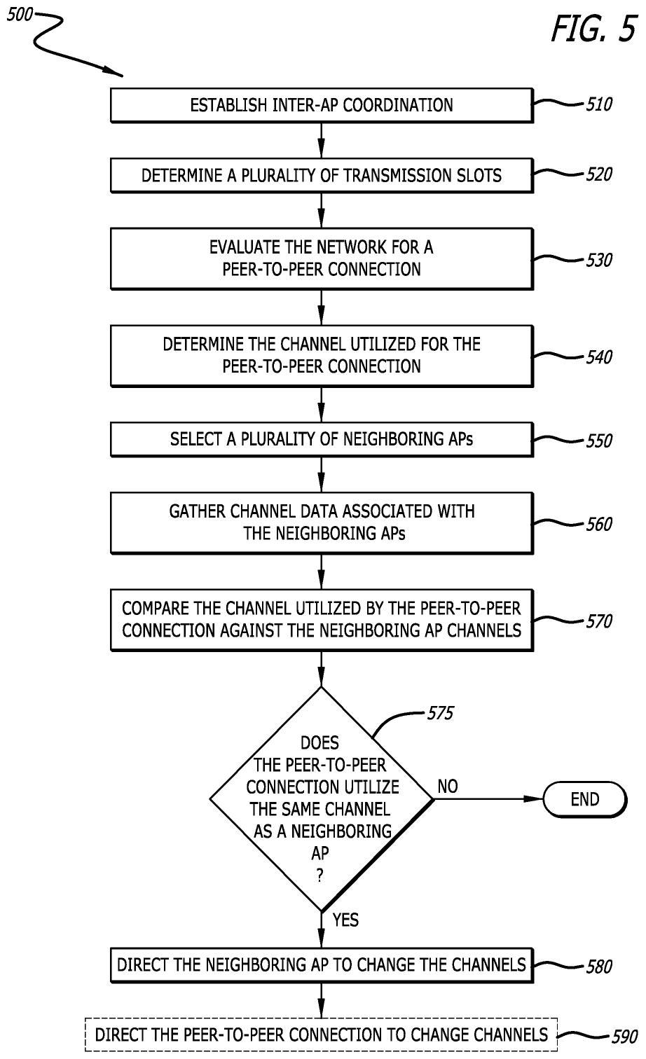

Referring to FIG. 5, a flowchart depicting a process 500 for directing peer-to-peer communications in accordance with various embodiments of the disclosure is shown. In many embodiments, the process 500 can establish an inter-access point (AP) coordination (block 510). This coordination process can encompass several key aspects aimed at optimizing network performance and efficiency. Channel selection can occur, as APs coordinate to choose appropriate channels to operate on, minimizing interference between neighboring APs and enhancing overall network stability. Load balancing mechanisms can then be employed to ensure equitable distribution of client devices among APs, mitigating network congestion and optimizing resource utilization. Resource management can occur to play a significant role in optimizing network performance, encompassing bandwidth allocation, Quality of Service (QoS) policies, and traffic prioritization based on application requirements. Interference mitigation strategies may also be employed to reduce interference from neighboring networks, utilizing techniques such as transmit power control and dynamic channel assignment. Security coordination ensures consistent and robust security policies across APs, including authentication and encryption key management.

In a number of embodiments, the process 500 can determine a plurality of transmission slots (block 520). In wireless networking, transmission slots can often refer to predefined time intervals during which data transmission occurs within the network. These slots are typically part of a scheduling mechanism used to organize and manage communication among devices, particularly in scenarios where multiple devices share access to the wireless medium. Transmission slots can serve several purposes, including, but not limited to, facilitating orderly access to the network, minimizing collisions between concurrent transmissions, and enabling efficient allocation of resources. Depending on the specific protocol and network architecture, transmission slots may vary in duration and frequency, with some systems utilizing fixed-length slots while others employ dynamic slot allocation algorithms. For example, in Time Division Multiple Access (TDMA) systems, transmission slots are allocated to different devices in a synchronized manner, allowing each device to transmit data during its assigned slot without interference from other devices. Similarly, in contention-based protocols like Carrier Sense Multiple Access with Collision Avoidance (CSMA/CA), devices contend for access to the medium and may be allocated transmission slots dynamically based on access contention and network congestion.

In more embodiments, the process 500 can evaluate the network for a peer-to-peer connection (block 530). In some embodiments, determining the presence of a peer-to-peer (P2P) connections can typically involve a network device engaging in various discovery mechanisms to identify and establish direct communication with other compatible devices within its vicinity. One common approach is through the use of discovery protocols or techniques such as Wi-Fi Direct, Bluetooth, or Universal Plug and Play (UPnP). These protocols can enable devices to actively scan their surrounding environment for other devices advertising their availability for P2P communication. Upon detecting potential peers, the device may initiate a discovery process, exchanging discovery messages or broadcasting its own presence to nearby devices. In certain embodiments, the process 500 can determine the presence of a peer-to-peer connection by being notified by another device that a peer-to-peer connection has been established on that device.

In further embodiments, the process 500 can determine the channel utilized for the peer-to-peer connection (block 540). In various embodiments, determining the channels being used by a peer-to-peer (P2P) connection in another network device can typically involve a process of channel scanning and analysis. A network device interested in identifying the channels used by a P2P connection in another device may first engage in a scanning operation across the relevant frequency bands. This scanning process can involve tuning into different channels within the frequency range supported by the wireless protocol being used, such as Wi-Fi or Bluetooth. Once the device has scanned across the channels, it can listen for P2P communication signals or beacons that may indicate the presence of P2P connections on specific channels. These signals may contain information such as device identifiers, connection parameters, or service advertisements. Additionally, in certain embodiments, advanced techniques like spectrum analysis and signal processing may be employed to enhance the accuracy and efficiency of channel detection in complex wireless environments. In more embodiments, the channel can be determined by receiving a signal or message from another device indicating what channel(s) are being used for P2P communications.

In additional embodiments, the process 500 can select a plurality of neighboring access points (block 550). As those skilled in the art will recognize, neighboring access points (APs) are wireless network nodes within the vicinity of another access point that share overlapping coverage areas and/or frequencies. These APs are typically deployed within close proximity to each other to ensure seamless coverage across the entire network area. Neighboring APs can be detected and identified by each other through various mechanisms such as beacon signals, probe requests, or active scanning. Once identified, neighboring APs can exchange information about their presence, capabilities, and network configurations, allowing them to coordinate and optimize their operations. These operations can include selecting on or more neighboring APs as part of the process 500.

In still more embodiments, the process 500 can gather channel data associated with the neighboring APs (block 560). In certain embodiments, channel data can include information about the utilization and congestion levels of different channels within the network's frequency spectrum. By monitoring channel data, the device can identify channels with low interference and congestion, allowing it to select the most suitable channel for transmission. In some additional embodiments, the process 500 can collect data on channel frequency, signal strength, noise levels, and signal-to-noise ratio (SNR) for each channel, providing insights into the quality of communication and potential sources of interference. Other relevant channel data may include information about neighboring access points and their operating channels, facilitating efficient channel selection and interference avoidance strategies. Moreover, in some embodiments, the process 500 may employ spectrum analysis techniques to gather detailed information about the spectral environment, identifying non-Wi-Fi sources of interference and optimizing channel usage accordingly.

In yet further embodiments, the process 500 can compare the channel utilized by the peer-to-peer connection against the neighboring AP channels (block 570). This comparison can be done by comparing channel frequency values. However, other comparisons and/or matching can be done on various other aspects of channel data.

In various embodiments, the process 500 can determine if the peer-to-peer connection(s) utilize the same channel as a neighboring AP (block 575). This determination can be done as a result of the comparison previously done. If there is not a channel conflict (i.e., the channel is not the same) then the process 500 can end.

However, if the process 500 does determine that a peer-to-peer connection utilizes a similar channel to a neighboring AP, then the process 500 can direct the neighboring AP to change a channel (block 580). This direction can be via one or more signals and/or messages to the device. In certain embodiments, the process 500 alter one or more characteristics of the network configurations to trigger a change in channels by one or more devices to avoid a channel conflict.

In some optional embodiments, the process 500 may direct the peer-to-peer connection to change channels (block 590). In these embodiments, the end client device that is managing the peer-to-peer connection may be directed to change the channel of that connection or to direct the peer-to-peer device to change channels. However, the peer-to-peer device may simply react to one or more network condition change to change the channel without being directly directed by the process 500.

Although a specific embodiment for directing peer-to-peer communications suitable for carrying out the various steps, processes, methods, and operations described herein is discussed with respect to FIG. 5, any of a variety of systems and/or processes may be utilized in accordance with embodiments of the disclosure. For example, this process 500 may occur between two devices, such as those shown in the embodiment depicted in FIG. 4. However, this may occur across a plurality of different devices wherein multiple conflicts may occur. The elements depicted in FIG. 5 may also be interchangeable with other elements of FIGS. 1-4 and 6-9 as required to realize a particularly desired embodiment.

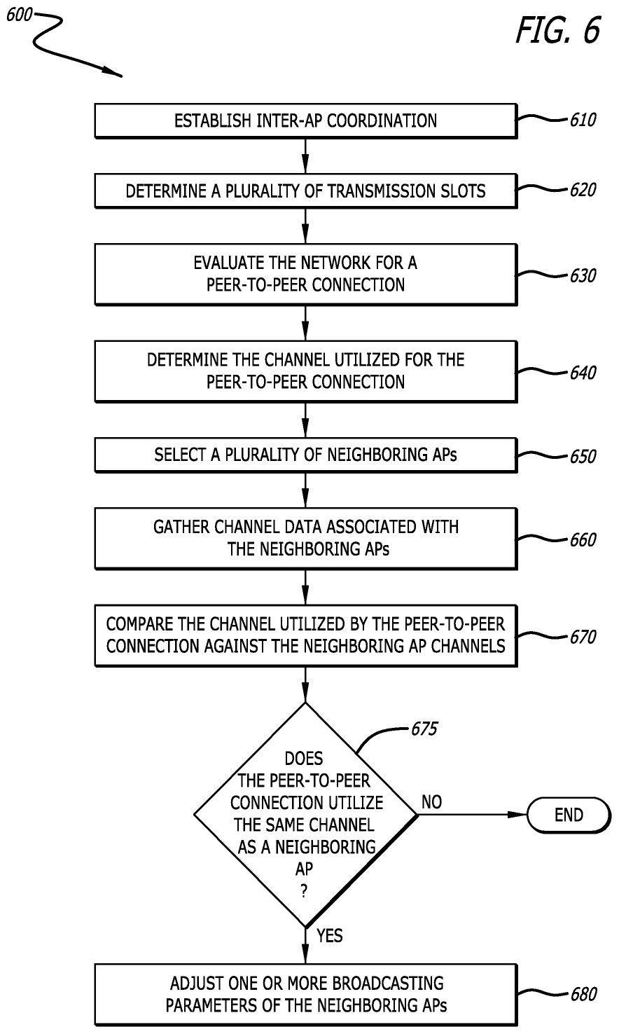

Referring to FIG. 6, a flowchart depicting a process 600 for managing neighboring access points in accordance with various embodiments of the disclosure is shown. In many embodiments, the process 500 can establish an inter-access point (AP) coordination (block 610). As stated above within the embodiments disclosed in FIG. 5, this coordination process can encompass several key aspects aimed at optimizing network performance and efficiency. Channel selection can occur, as APs coordinate to choose appropriate channels to operate on, minimizing interference between neighboring APs and enhancing overall network stability. Load balancing mechanisms can then be employed to ensure equitable distribution of client devices among APs, mitigating network congestion and optimizing resource utilization. Resource management can occur to play a significant role in optimizing network performance, encompassing bandwidth allocation, Quality of Service (QoS) policies, and traffic prioritization based on application requirements. Interference mitigation strategies may also be employed to reduce interference from neighboring networks, utilizing techniques such as transmit power control and dynamic channel assignment. Security coordination ensures consistent and robust security policies across APs, including authentication and encryption key management.

In a number of embodiments, the process 600 can determine a plurality of transmission slots (block 620). In wireless networking, transmission slots can often refer to predefined time intervals during which data transmission occurs within the network. These slots are typically part of a scheduling mechanism used to organize and manage communication among devices, particularly in scenarios where multiple devices share access to the wireless medium. Transmission slots can serve several purposes, including, but not limited to, facilitating orderly access to the network, minimizing collisions between concurrent transmissions, and enabling efficient allocation of resources. Depending on the specific protocol and network architecture, transmission slots may vary in duration and frequency, with some systems utilizing fixed-length slots while others employ dynamic slot allocation algorithms.

In more embodiments, the process 600 can evaluate the network for a peer-to-peer connection (block 630). In some embodiments, determining the presence of a peer-to-peer (P2P) connections can typically involve a network device engaging in various discovery mechanisms to identify and establish direct communication with other compatible devices within its vicinity. One common approach is through the use of discovery protocols or techniques such as Wi-Fi Direct, Bluetooth, or Universal Plug and Play (UPnP). These protocols can enable devices to actively scan their surrounding environment for other devices advertising their availability for P2P communication. Upon detecting potential peers, the device may initiate a discovery process, exchanging discovery messages or broadcasting its own presence to nearby devices. In certain embodiments, the process 600 can determine the presence of a peer-to-peer connection by being notified by another device that a peer-to-peer connection has been established on that device.

In further embodiments, the process 600 can determine the channel utilized for the peer-to-peer connection (block 640). In various embodiments, determining the channels being used by a peer-to-peer (P2P) connection in another network device can typically involve a process of channel scanning and analysis. A network device interested in identifying the channels used by a P2P connection in another device may first engage in a scanning operation across the relevant frequency bands. This scanning process can involve tuning into different channels within the frequency range supported by the wireless protocol being used, such as Wi-Fi or Bluetooth. Once the device has scanned across the channels, it can listen for P2P communication signals or beacons that may indicate the presence of P2P connections on specific channels. These signals may contain information such as device identifiers, connection parameters, or service advertisements. Additionally, in certain embodiments, advanced techniques like spectrum analysis and signal processing may be employed to enhance the accuracy and efficiency of channel detection in complex wireless environments. In more embodiments, the channel can be determined by receiving a signal or message from another device indicating what channel(s) are being used for P2P communications.

In additional embodiments, the process 600 can select a plurality of neighboring access points (block 650). As those skilled in the art will recognize, neighboring access points (APs) are wireless network nodes within the vicinity of another access point that share overlapping coverage areas and/or frequencies. These APs are typically deployed within close proximity to each other to ensure seamless coverage across the entire network area. Neighboring APs can be detected and identified by each other through various mechanisms such as beacon signals, probe requests, or active scanning. Once identified, neighboring APs can exchange information about their presence, capabilities, and network configurations, allowing them to coordinate and optimize their operations. These operations can include selecting on or more neighboring APs as part of the process 600.

In still more embodiments, the process 600 can gather channel data associated with the neighboring APs (block 660). In certain embodiments, channel data can include information about the utilization and congestion levels of different channels within the network's frequency spectrum. By monitoring channel data, the device can identify channels with low interference and congestion, allowing it to select the most suitable channel for transmission. In some additional embodiments, the process 600 can collect data on channel frequency, signal strength, noise levels, and signal-to-noise ratio (SNR) for each channel, providing insights into the quality of communication and potential sources of interference. Other relevant channel data may include information about neighboring access points and their operating channels, facilitating efficient channel selection and interference avoidance strategies. Moreover, in some embodiments, the process 500 may employ spectrum analysis techniques to gather detailed information about the spectral environment, identifying non-Wi-Fi sources of interference and optimizing channel usage accordingly.

In yet further embodiments, the process 600 can compare the channel utilized by the peer-to-peer connection against the neighboring AP channels (block 670). This comparison can be done by comparing channel frequency values. However, other comparisons can be done on various other aspects of channel data.

In various embodiments, the process 600 can determine if the peer-to-peer connection(s) utilize the same channel as a neighboring AP (block 675). This determination can be done as a result of the comparison previously done. If there is not a channel conflict (i.e., the channel is not the same) then the process 600 can end.

However, if the process 600 does determine that a peer-to-peer connection utilizes a similar channel to a neighboring AP, then the process 600 can adjust one or more broadcasting parameters of the neighboring APs. These parameters may encompass aspects such as the SSID, which serves as the network identifier enabling devices to connect, and the beacon interval, determining the frequency at which access points broadcast beacon frames containing network information. Wireless modes and standards, including 802.11 protocols, can define modulation techniques and compatibility, shaping overall network performance. Furthermore, identifiers like the BSSID uniquely identify each Basic Service Set (BSS) within the network, helping devices distinguish between different access points. Certain embodiments of the process 600 can allow for configuration of these broadcasting parameters to allow for optimization of network performance, coverage, security tailored to specific deployment needs and environmental conditions, and/or channel conditions.

Although a specific embodiment for managing neighboring access points suitable for carrying out the various steps, processes, methods, and operations described herein is discussed with respect to FIG. 6, any of a variety of systems and/or processes may be utilized in accordance with embodiments of the disclosure. For example, the process 600 can be operated by a coordinating device, an access point, or a remote-based service provider. The elements depicted in FIG. 6 may also be interchangeable with other elements of FIGS. 1-5 and 7-9 as required to realize a particularly desired embodiment.

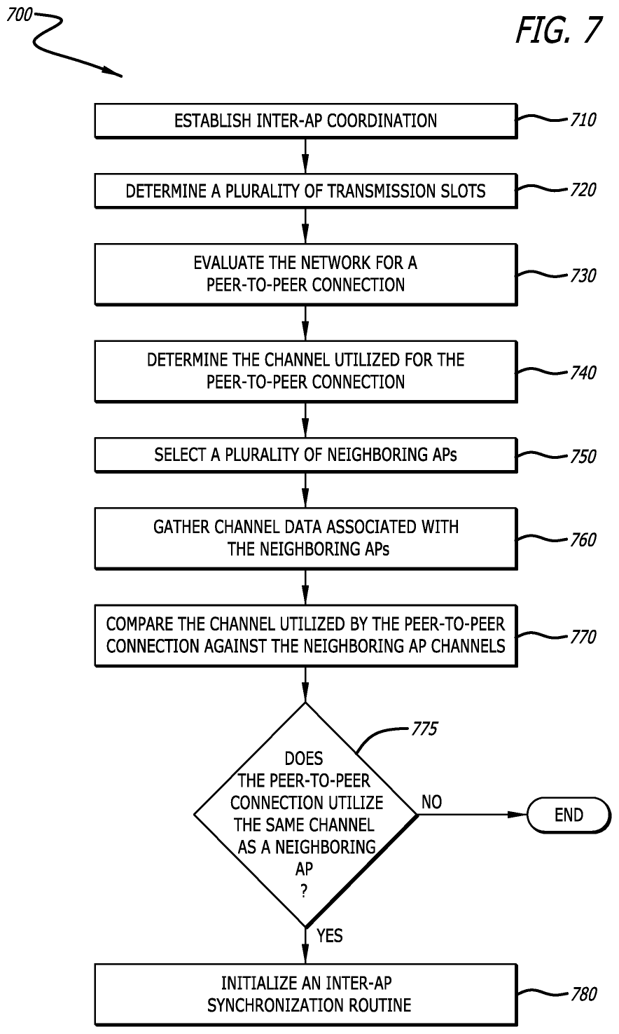

Referring to FIG. 7, a flowchart depicting a process 700 for initializing an inter-access point synchronization routine in accordance with various embodiments of the disclosure is shown. In many embodiments, the process 500 can establish an inter-access point (AP) coordination (block 710). As stated above within the embodiments disclosed in FIGS. 5 and 6, this coordination process can encompass several key aspects aimed at optimizing network performance and efficiency. Channel selection can occur, as APs coordinate to choose appropriate channels to operate on, minimizing interference between neighboring APs and enhancing overall network stability. Load balancing mechanisms can then be employed to ensure equitable distribution of client devices among APs, mitigating network congestion and optimizing resource utilization. Resource management can occur to play a significant role in optimizing network performance, encompassing bandwidth allocation, Quality of Service (QoS) policies, and traffic prioritization based on application requirements. Interference mitigation strategies may also be employed to reduce interference from neighboring networks, utilizing techniques such as transmit power control and dynamic channel assignment. Security coordination ensures consistent and robust security policies across APs, including authentication and encryption key management.

In a number of embodiments, the process 600 can determine a plurality of transmission slots (block 720). In wireless networking, transmission slots can often refer to predefined time intervals during which data transmission occurs within the network. These slots are typically part of a scheduling mechanism used to organize and manage communication among devices, particularly in scenarios where multiple devices share access to the wireless medium. Transmission slots can serve several purposes, including, but not limited to, facilitating orderly access to the network, minimizing collisions between concurrent transmissions, and enabling efficient allocation of resources. Depending on the specific protocol and network architecture, transmission slots may vary in duration and frequency, with some systems utilizing fixed-length slots while others employ dynamic slot allocation algorithms.

In more embodiments, the process 700 can evaluate the network for a peer-to-peer connection (block 730). In some embodiments, determining the presence of a peer-to-peer (P2P) connections can typically involve a network device engaging in various discovery mechanisms to identify and establish direct communication with other compatible devices within its vicinity. One common approach is through the use of discovery protocols or techniques such as Wi-Fi Direct, Bluetooth, or Universal Plug and Play (UPnP). These protocols can enable devices to actively scan their surrounding environment for other devices advertising their availability for P2P communication. Upon detecting potential peers, the device may initiate a discovery process, exchanging discovery messages or broadcasting its own presence to nearby devices. In certain embodiments, the process 700 can determine the presence of a peer-to-peer connection by being notified by another device that a peer-to-peer connection has been established on that device.

In further embodiments, the process 700 can determine the channel utilized for the peer-to-peer connection (block 740). In various embodiments, determining the channels being used by a peer-to-peer (P2P) connection in another network device can typically involve a process of channel scanning and analysis. A network device interested in identifying the channels used by a P2P connection in another device may first engage in a scanning operation across the relevant frequency bands. This scanning process can involve tuning into different channels within the frequency range supported by the wireless protocol being used, such as Wi-Fi or Bluetooth. Once the device has scanned across the channels, it can listen for P2P communication signals or beacons that may indicate the presence of P2P connections on specific channels. These signals may contain information such as device identifiers, connection parameters, or service advertisements. Additionally, in certain embodiments, advanced techniques like spectrum analysis and signal processing may be employed to enhance the accuracy and efficiency of channel detection in complex wireless environments. In more embodiments, the channel can be determined by receiving a signal or message from another device indicating what channel(s) are being used for P2P communications.

In additional embodiments, the process 700 can select a plurality of neighboring access points (block 750). As those skilled in the art will recognize, neighboring access points (APs) are wireless network nodes within the vicinity of another access point that share overlapping coverage areas and/or frequencies. These APs are typically deployed within close proximity to each other to ensure seamless coverage across the entire network area. Neighboring APs can be detected and identified by each other through various mechanisms such as beacon signals, probe requests, or active scanning. Once identified, neighboring APs can exchange information about their presence, capabilities, and network configurations, allowing them to coordinate and optimize their operations. These operations can include selecting on or more neighboring APs as part of the process 700.

In still more embodiments, the process 600 can gather channel data associated with the neighboring APs (block 760). In certain embodiments, channel data can include information about the utilization and congestion levels of different channels within the network's frequency spectrum. By monitoring channel data, the device can identify channels with low interference and congestion, allowing it to select the most suitable channel for transmission. In some additional embodiments, the process 700 can collect data on channel frequency, signal strength, noise levels, and signal-to-noise ratio (SNR) for each channel, providing insights into the quality of communication and potential sources of interference. Other relevant channel data may include information about neighboring access points and their operating channels, facilitating efficient channel selection and interference avoidance strategies. Moreover, in some embodiments, the process 500 may employ spectrum analysis techniques to gather detailed information about the spectral environment, identifying non-Wi-Fi sources of interference and optimizing channel usage accordingly.

In yet further embodiments, the process 700 can compare the channel utilized by the peer-to-peer connection against the neighboring AP channels (block 770). This comparison can be done by comparing channel frequency values. However, other comparisons can be done on various other aspects of channel data.

In various embodiments, the process 700 can determine if the peer-to-peer connection(s) utilize the same channel as a neighboring AP (block 775). This determination can be done as a result of the comparison previously done. If there is not a channel conflict (i.e., the channel is not the same) then the process 700 can end.

However, if the process 700 does determine that a peer-to-peer connection utilizes a similar channel to a neighboring AP, then the process 700 can initialize an inter-AP synchronization routine (block 780).

Typically, these routines can involve APs periodically exchanging synchronization messages to align their timing and configuration parameters. Initially, APs establish a synchronization hierarchy, designating a primary AP and other APs as secondaries. The primary AP can periodically broadcast synchronization beacons containing timing information and configuration updates. Secondary APs can listen for these beacons and adjust their internal clocks and operational parameters accordingly to maintain synchronization with the master AP. This synchronization can ensure that APs transmit and receive data within predefined time slots, minimizing collisions and interference between neighboring APs. In more embodiments, the routine can involve an extended and/or concatenated TxOP schedule to allow for managing channel conflicts between neighboring APs and other proximate peer-to-peer connections.

Although a specific embodiment for initializing an inter-access point synchronization routine suitable for carrying out the various steps, processes, methods, and operations described herein is discussed with respect to FIG. 7, any of a variety of systems and/or processes may be utilized in accordance with embodiments of the disclosure. For example, the type of TxOP schedule utilized may vary based on the scheduling desired. In many embodiments, the scheduling can be coordinated from a coordinating device, such as, but not limited to, a MAPC device. The elements depicted in FIG. 7 may also be interchangeable with other elements of FIGS. 1-6 and 8-9 as required to realize a particularly desired embodiment.

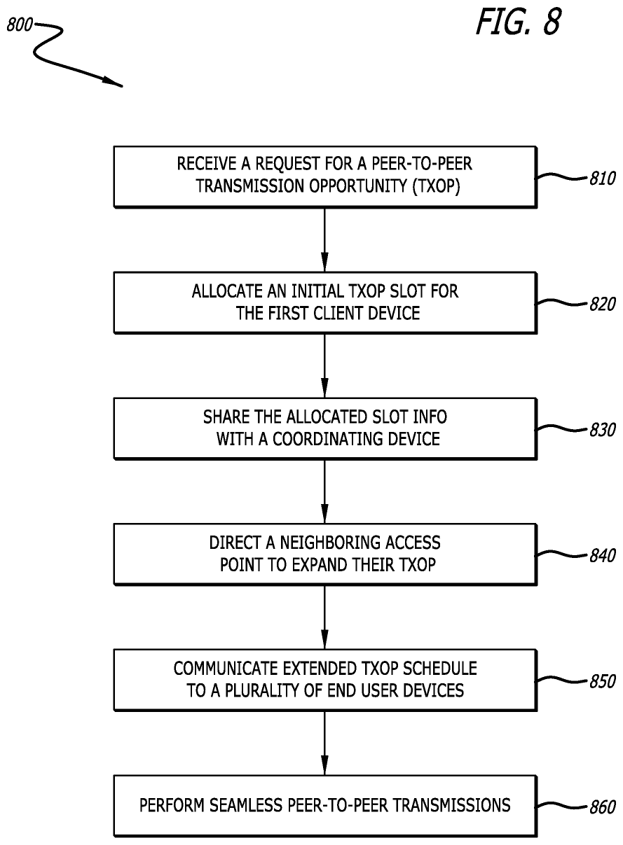

Referring to FIG. 8, a flowchart depicting a process 800 for transmission opportunity scheduling between access points in accordance with various embodiments of the disclosure is shown. In many embodiments, the process 800 can receive a request for a peer-to-peer transmission opportunity (TxOP) (block 810). Processing requests for peer-to-peer (P2P) transmission opportunities can involve a series of steps aimed at facilitating direct communication between wireless devices without the need for an intermediate infrastructure. Typically, when a device desires to initiate a P2P transmission, it may send out a request message to potential peers within its vicinity. This request may include information about the desired service, data to be exchanged, or communication parameters. Upon receiving the request, neighboring devices capable of P2P communication can evaluate the request and determine whether they can fulfill the request based on their capabilities and current state. This evaluation may involve checking factors such as device compatibility, available resources, and network conditions. If a peer device is willing and able to accommodate the request, it may respond with an acknowledgment message, indicating its readiness to establish a P2P connection. Subsequently, the devices negotiate connection parameters, such as a communication channel, data rates, and security settings, to ensure seamless and secure data exchange. Once the connection is established, the devices can transmit data directly to each other, bypassing the need for a central access point or network infrastructure. Throughout this process, robust protocols and algorithms govern communication, ensuring reliable and efficient P2P transmission opportunities while addressing challenges such as device discovery, authentication, and interference mitigation. These transmission opportunity requests can be sent to one or more devices for processing and thus received by the process 800.

In a number of embodiments, the process 800 can allocate an initial TxOP slot for the first client device (block 820). Allocating initial transmission opportunity slots in wireless networking can involve the process of assigning time intervals for devices to initiate communication within the network. Typically, this allocation is managed by a central entity, such as an access point or a coordinating device, using various scheduling algorithms and protocols. In some embodiments, the process 800 may broadcast beacon frames or synchronization signals to inform devices about the availability of transmission opportunities and synchronization parameters. Devices within the network may then contend for these initial transmission slots using contention-based protocols such as Carrier Sense Multiple Access with Collision Avoidance (CSMA/CA) or Time Division Multiple Access (TDMA). In CSMA/CA, devices listen for a quiet channel before transmitting data, while in TDMA, devices are assigned specific time slots for transmission. The allocation of initial transmission slots may take into account factors such as device priorities, Quality of Service (QoS) requirements, and network congestion levels. Additionally, mechanisms like clear channel assessment and backoff algorithms can be used to manage contention and mitigate collisions, ensuring fair and efficient access to transmission opportunities. As the network evolves and traffic patterns change, the allocation of transmission slots may be dynamically adjusted to adapt to varying network conditions and optimize performance.

In more embodiments, the process 800 can share the allocated slot info with a coordinating device (block 830). The allocated slot info may, in various embodiments, be transmitted to a MAPC device and can be utilized as an input within one or more MAPC decisions. However, in some embodiments, the allocated slot info/schedule may be initially generated by the coordinating device and can be communicated to the process 800.

In additional embodiments, the process 800 can direct a neighboring AP to expand their TxOP (block 840).

Expanding or otherwise extending a transmission opportunity in wireless networking can refer to the process of prolonging the time interval during which a device has the opportunity to transmit data within the network. This extension may be necessary in scenarios where the device requires additional time to complete its transmission due to factors such as large data payloads, high network congestion, or contention with other devices. The extension of a transmission opportunity can be facilitated through various mechanisms and protocols, depending on the network architecture and communication protocols in use. For example, in contention-based protocols like CSMA/CA, a device may request an extension of its transmission opportunity by deferring to other devices and reattempting transmission after a predetermined backoff period. Alternatively, in scheduled access protocols like TDMA, the central coordinating entity can dynamically adjust the duration of time slots allocated to devices based on their communication requirements and network conditions. This extension process may involve signaling between the transmitting device and the network infrastructure to negotiate and coordinate the extended transmission opportunity. In certain embodiments, the expansion can allow for the transmission of a concatenated TxOP schedule.

In further embodiments, the process 800 can communicate an extended TxOP schedule to a plurality of end user devices (block 850). As those end user devices may require communication with wireless network devices, the extended TxOP schedule can be sent to those devices to abide by the schedule. In more embodiments, the end user devices can notify the process 800 that the schedule has been received and/or will be followed or is otherwise accepted.

In still more embodiments, the process 800 can perform a seamless peer-to-peer transmission (block 860). Once transmitted and/or verified as accepted, the data associated with the extended TxOPs can occur to minimize channel conflicts and thus increase the overall efficiency of the wireless network infrastructure. As those skilled in the art will recognize, the data associated with the transmission can be completely transferred during the TxOP, but may be broken up to be transferred over multiple TxOPs.

Although a specific embodiment for transmission opportunity scheduling between access suitable for carrying out the various steps, processes, methods, and operations described herein is discussed with respect to FIG. 8, any of a variety of systems and/or processes may be utilized in accordance with embodiments of the disclosure. For example, process 800 can occur within an access point, across multiple network devices, or as a remote-based service. The elements depicted in FIG. 8 may also be interchangeable with other elements of FIGS. 1-7 and 9 as required to realize a particularly desired embodiment.

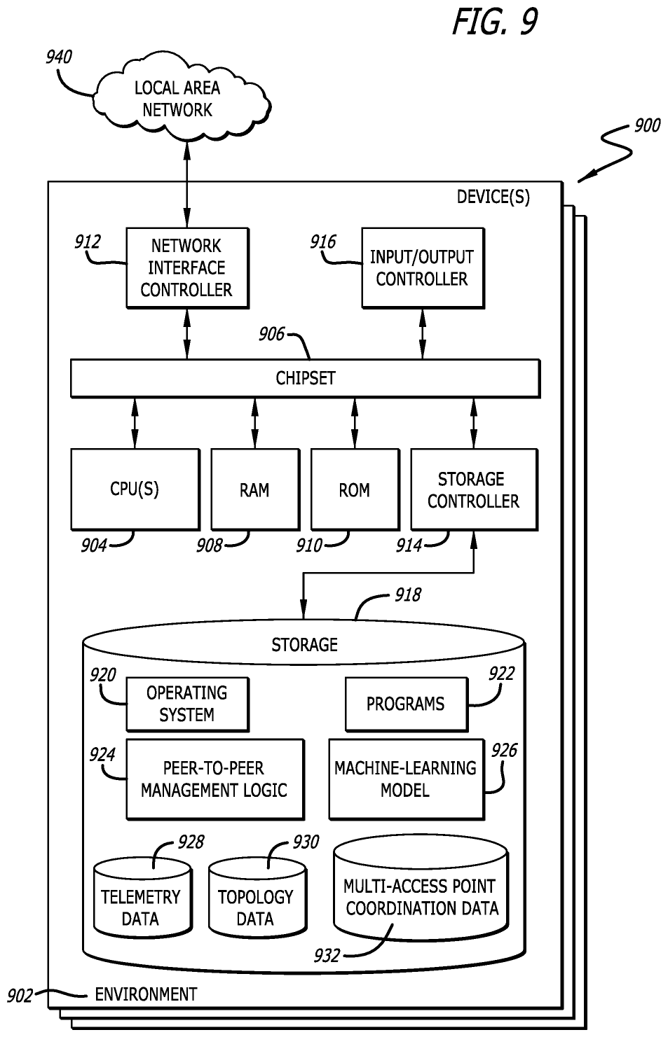

Referring to FIG. 9, a conceptual block diagram of a device 900 suitable for configuration with a peer-to-peer management logic 924, in accordance with various embodiments of the disclosure is shown. The embodiment of the conceptual block diagram depicted in FIG. 9 can illustrate a conventional server, switch, wireless LAN controller, access point, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 9 can also illustrate an access point, a switch, or a router in accordance with various embodiments of the disclosure. The device 900 may, in many non-limiting examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, applications 922. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In many more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-8. In certain embodiments, the device 900 can also include computer-readable storage media having instructions stored thereupon for performing any of the other computer-implemented operations described herein.

In many further embodiments, the device 900 may include a peer-to-peer management logic 924. The peer-to-peer management logic 924 can be configured to perform one or more of the various steps, processes, operations, and/or other methods that are described above. Often, the peer-to-peer management logic 924 can be a set of instructions stored within a non-volatile memory that, when executed by the processor(s)/controller(s) 904 can carry out these steps, etc. In some embodiments, the peer-to-peer management logic 924 may be a client application that resides on a network-connected device, such as, but not limited to, a server, switch, personal or mobile computing device in a single or distributed arrangement.

In some embodiments, telemetry data 928 can encompass real-time measurements crucial for monitoring and optimizing network performance. It may include details like bandwidth usage, latency, packet loss, and error rates, providing insights into data transmission quality and identifying potential issues. Telemetry data 928 may also cover traffic patterns and application performance, supporting capacity planning and ensuring optimal user experience. The collection and analysis of this data are essential for proactive network management, facilitated by advanced monitoring tools and technologies.

In various embodiments, topology data 930 can comprise information detailing the physical or logical arrangement of network devices and their interconnections. This data can provide insights into the structure of the network, including the relationships between routers, switches, servers, and other components. Topology data 930 can describe the actual layout of devices, such as their placement in a building or across multiple locations, while logical topology data may focus on the communication paths and relationships between devices regardless of their physical location. Understanding network topology is crucial for troubleshooting, optimizing performance, and planning for scalability. It can enable network administrators to identify potential points of failure, ensure efficient data flow, and make informed decisions about network expansion or reconfiguration. Advanced tools and technologies are often employed to visualize and analyze topology data 930, aiding in the effective management and maintenance of complex network infrastructures.

In a number of embodiments, multi-access point coordination (MAPC) data 932 may comprise detailed information about a range of information for effectively managing and optimizing a wireless network infrastructure featuring multiple access points. This data can include configurations, coverage maps, and performance metrics aimed at ensuring seamless connectivity. Access point configurations, such as channel assignments and security settings, may be recorded alongside coverage maps detailing signal strength, quality, and potential dead zones. Additionally, MAPC data 932 can be configured to encompass the tracking of client roaming behavior, load balancing strategies, and interference monitoring to enhance network performance and reliability. Security events, including unauthorized access attempts and rogue access point detections, may also be logged for mitigation within the MAPC data 932. As previously described, MAPC data 932 may also comprise data related to transmission opportunities, potential channel conflicts, and an enhanced or otherwise expanded transmission opportunities schedule.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

Finally, in numerous additional embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926.

The ML model(s) 926 can be configured to generate inferences to make predictions or draw conclusions from data. An inference can be considered the output of a process of applying a model to new data. This can occur by learning from at least the telemetry data 928, the power topology data 930, and the station data 932. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes.

Although a specific embodiment for a device suitable for configuration with the peer-to-peer management logic for carrying out the various steps, processes, methods, and operations described herein is discussed with respect to FIG. 9, any of a variety of systems and/or processes may be utilized in accordance with embodiments of the disclosure. For example, the device 900 may be in a virtual environment such as a cloud-based network administration suite, or it may be distributed across a variety of network devices or APs. The elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
at least one wireless transceiver configured to provide access to a network; and
a memory communicatively coupled to the processor, wherein the memory comprises a peer-to-peer management logic that is configured to:
configure the at least one wireless transceiver on a first transmission channel;
receive a request for a first transmission opportunity (TxOP);
allocate an initial TxOP slot schedule for a first client device;
share the initial TxOP slot schedule with a coordinating device;
receive an expanded TxOP slot schedule; and
transmit the expanded TxOP slot schedule to one or more end user devices.

2. The device of claim 1, wherein the first transmission opportunity is a peer-to-peer transmission opportunity (TxOP).

3. The device of claim 2, wherein the peer-to-peer TxOP is received from the first client device.

4. The device of claim 3, wherein the first client device is configured with a peer-to-peer connection with a first peer-to-peer device.

5. The device of claim 4, wherein the expanded TxOP slot schedule is associated with a neighboring access point.

6. The device of claim 5, wherein the neighboring access point is configured to execute the expanded TxOP slot schedule with a second client device.

7. The device of claim 6, wherein the second client device is configured with a peer-to-peer connection to a second peer-to-peer device.

8. The device of claim 7, wherein the second peer-to-peer device is configured with a wireless transceiver.

9. The device of claim 8, wherein the wireless transceiver of the second peer-to-peer device is also configured on the first transmission channel.

10. The device of claim 9, wherein the expanded TxOP slot schedule is configured to avoid interference between transmissions occurring on the first transmission channel.

11. The device of claim 1, wherein the coordinating device is a multi-access point coordinator (MAPC) device.

12. The device of claim 4, wherein the peer-to-peer management logic is further configured to perform a data transfer.

13. A device, comprising:
a processor;
at least one network interface configured to provide access to a network; and
a memory communicatively coupled to the processor, wherein the memory comprises a peer-to-peer management logic that is configured to:
establish an inter-access point communication with at least a first access point and a second access point;
receive an indication of a peer-to-peer connection;
select a plurality of neighboring access points;
gather channel data associated with the peer-to-peer connection and the plurality of neighboring access points; and
compare the channel data associated with the peer-to-peer connection to the channel data associated with the neighboring access points; and
initialize, in response to the channel data matching the peer-to-peer connection, an inter-access point synchronization routine.

14. The device of claim 13, wherein the peer-to-peer connection is between a peer-to-peer device and an end user device in wireless communication with the first access point or the second access point.

15. The device of claim 14, wherein the plurality of neighboring access points are selected based on their proximity to the first access point associated with the peer-to-peer connection.

16. The device of claim 13, wherein the channel data is configured to indicate a wireless channel being utilized by a wireless transceiver.

17. The device of claim 13, wherein the inter-access point synchronization routine is a multi-access point coordination routine.

18. The device of claim 13, wherein the peer-to-peer device is further configured to determine a plurality of transmission opportunity (TxOP) schedules.

19. A method of managing peer-to-peer connections, comprising:
configuring a transceiver to a first transmission channel;
receiving a request for a first transmission opportunity (TxOP);
allocating an initial TxOP slot schedule for a first client device;
sharing the initial TxOP slot schedule with a coordinating device;
receiving an expanded TxOP slot schedule; and
transmitting the expanded TxOP slot schedule to one or more end user devices.

20. The method of claim 19, wherein the method further comprises transmitting data according to the expanded TxOP slot schedule.
